(19) United States
(12) Patent Application Publication
(10) Pub. No.: US 2009/0246574 A1
(43) Pub. Date: Oct. 1, 2009

(54) FUEL CELL APPARATUS AND DRIVE METHOD THEREOF

(75) Inventor: Terumasa Nagasaki, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/391,952

(22) Filed: Feb. 24, 2009

(30) Foreign Application Priority Data
Mar. 31, 2008 (JP) 2008-093116

(51) Int. Cl. H01M 8/04

(52) U.S. Cl. 429/17; 429/23

(57) ABSTRACT

According to an embodiment, a fuel cell apparatus comprises an electromotive section including a cell including an anode and a cathode, and configured to generate electricity by a chemical reaction, a fuel tank configured to store fuel, a fuel channel configured to flow fuel through the anode, and an air channel configured to flow air through the cathode, a fuel supply device configured to supply fuel supplied from the fuel tank to the anode through the fuel channel, and a cell controller configured to control a generated electricity drawn out from the electromotive section and execute a refresh process for drawing out a current of a current value which is generated when an amount of air larger than the amount of air supplied to the cathode is consumed.

### CROSS-REFERENCE TO RELATED APPLICATIONS

This application is based upon and claims the benefit of priority from Japanese Patent Application No. 2008-093116, filed Mar. 31, 2008, the entire contents of which are incorporated herein by reference.

### BACKGROUND

1. Field

An embodiment of the present invention relates to a fuel cell apparatus used as a electricity supply of electronic equipment and the like and a drive method thereof.

2. Description of the Related Art

At present, secondary batteries, such as lithium ion batteries, are mainly used as energy sources for electronic devices, e.g., portable notebook personal computers (notebook PCs), mobile devices, etc. In recent years, small, high-output fuel cells that require no charging have been expected as new energy sources to meet the demands for increased energy consumption and prolonged use of these electronic devices with higher functions. Among various types of fuel cells, direct methanol fuel cells (DMFCs) that use a methanol solution as their fuel, in particular, enable easier handling of the fuel and a simpler system configuration, as compared with fuel cells that-use hydrogen as their fuel. Thus, the DMFCs are noticeable energy sources for the electronic devices.

Ordinarily, a fuel cell has a cell stack wherein single cells and separators are alternatively stacked. The single cell is arranged such that an electrolytic plate or an electrolytic layer of a solid high polymer electrolytic membrane and the like, which has a hydrogen ion (proton) transparent property, is sandwiched between two electrodes. Each of the separators has a groove as a channel of a reaction gas (for example, Jpn. Pat. Appln. KOKAI Publication No. 2005-293981). The single cell has a membrane and electrode joint member (hereinafter, called MEA), in which an anode (fuel electrode) is integrated with a cathode (air electrode), on both the surfaces of the high polymer electrolytic membrane. A methanol aqueous solution having a concentration of several percentages to several tenth of percentage is supplied to the anode through the channel of the cell stack, and air is supplied to the cathode.

An oxidation reaction of fuel occurs in the anode, methanol is reacted with water and oxidized, thereby carbon dioxide, protons, and electrons are created. The protons pass through the high polymer electrolytic membrane and migrate to the cathode. In the cathode, oxygen gas in air is coupled with hydrogen ions, electrons and reduced to thereby create water. In the above process, electrons flow in an external circuit, and a current is taken out.

In the fuel cell arranged as described above, oxidation of a cathode catalyst is exemplified as a factor of lowering an electricity generation output. That is, when the fuel cell is continuously operated, the cathode catalyst is exposed to air for a long period of time and oxidized. When the cathode catalyst is oxidized, a catalyst reaction is deteriorated, a cell voltage is gradually lowered, and thus electricity generation efficiency is deteriorated.

To cope with the above problem, for example, Jpn. Pat. Appln. KOKAI Publication No. 2005-243567 proposes a fuel cell system for executing a refresh process of a cell to restore electricity generation efficiency. According to the fuel cell system, a gas feed pump is stopped in a state that electricity generation is interrupted in the refresh process, and only a liquid feed pump is operated to remove bubbles of carbon dioxide deposited to an anode. Subsequently, electricity generation efficiency is restored by operating the gas feed pump up to the maximum capability thereof and removing water droplets deposited to a cathode.

It is possible to restore deterioration of electricity generation efficiency of a fuel cell and to obtain a high output for a long period of time by the refresh process as described above. However, in an arrangement in which air is caused to flow into a cathode channel by diffusion and convection of it, that is, in a so-called passive type DMFC which does not have a gas feed pump, since the refresh process as described above can not be executed, it is difficult to restore electricity generation efficiency.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram schematically showing an arrangement of a fuel cell apparatus according to a first embodiment of the present invention;

FIG. 2 is an exemplary sectional view showing a cell stack of the fuel cell apparatus;

FIG. 3 is an exemplary view schematically showing a single cell of the cell stack;

FIG. 4 is an exemplary flowchart showing an operation of a refresh process in the fuel cell apparatus;

FIG. 5 is an exemplary view showing a change of a cell voltage and a change of a current value drawn out from the cell stack in the fuel cell apparatus;

FIG. 6 is an exemplary flowchart showing an operation of the refresh process in a fuel cell apparatus according to a second embodiment of the present invention; and

FIG. 7 is an exemplary view showing a change of a current value drawn out from a cell stack in the fuel cell apparatus.

### DETAILED DESCRIPTION

Various embodiments according to the invention will be described hereinafter with reference to the accompanying drawings. In general, according to one embodiment of the invention, a fuel cell apparatus comprises: an electromotive section comprising a cell comprising an anode and a cathode, and configured to generate electricity by a chemical reaction; a fuel tank configured to store fuel; a fuel channel configured to flow fuel through the anode, and an air channel configured to flow air through the cathode; a fuel supply device configured to supply fuel supplied from the fuel tank to the anode through the fuel channel; and a cell controller configured to control a generated electricity drawn out from the electromotive section and execute a refresh process for drawing out a current of a current value which is generated when an amount of air larger than the amount of air supplied to the cathode is consumed.

According to another aspect of the invention, a method of driving a fuel cell apparatus comprising: drawing out an electricity of a current value which is generated when an amount of air larger than the amount of air supplied to the cathode is consumed; creating an insufficient air state in the cathode; and executing a refresh operation for reducing the cathode.

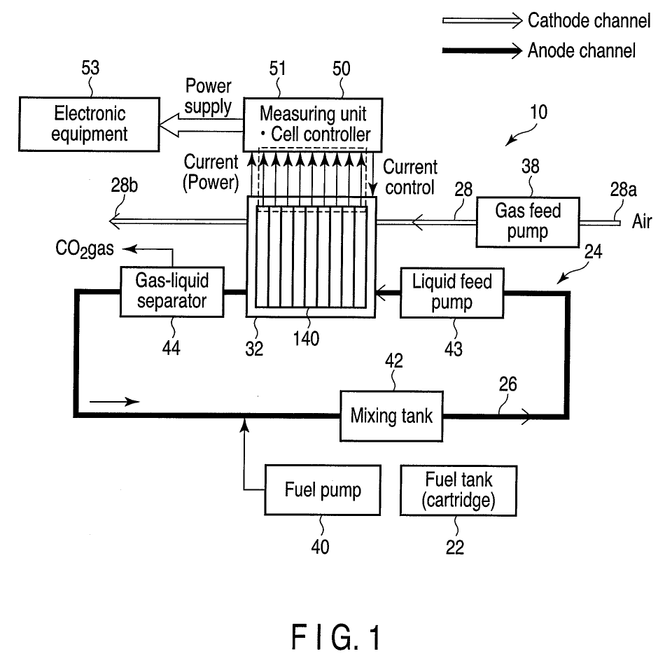

A fuel cell apparatus according to a first embodiment of the present invention will be explained below in detail referring to the drawings. FIG. 1 schematically shows an arrangement of the fuel cell apparatus. As shown in FIG. 1, the fuel cell apparatus 10 is arranged as a DMFC using methanol as liquid fuel. The fuel cell apparatus 10 comprises a cell stack 32 constituting an electromotive section, a fuel tank 22, a circulation system 24 for supplying fuel and air to the cell stack, and a cell controller 50 for controlling an operation of the overall fuel cell apparatus 10.

The fuel tank 22 has a hermetically-sealed structure and is formed as a fuel cartridge which can be detachably mounted on the fuel cell apparatus. The fuel tank 22 stores highly concentrated methanol as liquid fuel. When the fuel is consumed, the fuel tank.22 can be easily replaced.

The circulation system 24 has an anode channel (fuel channel system) 26 for circulating fuel supplied from the fuel tank 22 through the cell stack 32, a cathode channel (air channel system) 28 for circulating gas containing air through the cell stack 32, and a plurality of accessories disposed in the fuel channel and in the air channel. The anode channel 26 and the cathode channel 28 are formed of pipings and the like, respectively.

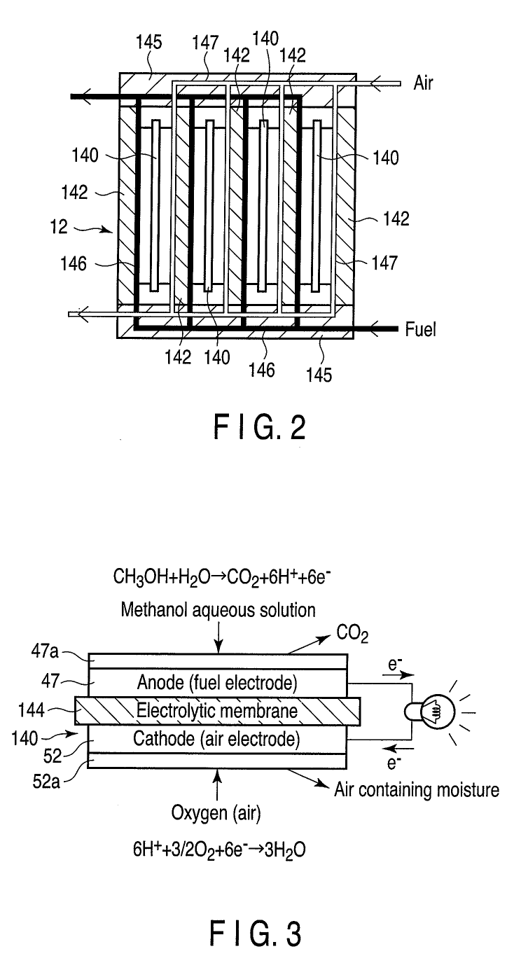

FIG. 2 shows a stacked structure of the cell stack 32, and FIG. 3 schematically shows an electricity generation reaction of respective cells. As shown in FIGS. 2 and 3, the cell stack 32 has a stacked body, which is composed by alternately laminating a plurality of, for example, four single cells 140 and five rectangular sheet-shaped separators 142, and a frame member 145 that supports the stacked body. Each single cell 140 has a membrane-electrode junction body (MEA) in which an approximately rectangular sheet-shaped cathode 52 and an approximately rectangular sheet shaped anode each having a catalyst layer and a carbon paper are integrated with an approximately rectangular high polymer electrolytic membrane 144 sandwiched between the cathode and the anode. An anode 47 has a fuel diffusion layer 47a formed thereto, and a cathode 52 is provided with a porous gas diffusion layer 52a . The high polymer electrolytic membrane 144 has an area larger than those of the anode 47 and the cathode 52.

Three separators 142 are stacked between two adjacent single cells 140 and the other two separators are stacked at both ends in a stacked layer direction, respectively. A fuel channel 146 for supplying fuel to the anodes 47 of the respective single cells 140 and an air channel 147 for supplying air to the cathodes 52 of the respective single cells are formed to the separators 142 and the frame member 145.

As shown in FIG. 3, the supplied fuel (methanol aqueous solution) and air are chemically reacted by the high polymer electrolytic membrane 144 interposed between the anode 47 and the cathode 52, and electricity is generated between the anode and the cathode by the chemical reaction.

Carbon dioxide is generated on the anode 47 side and water is generated on the cathode 52 side as reaction products by the electrochemical reaction. The electricity generated in the cell stack 32 is supplied to external equipment, for example, electronic equipment 53 through the cell controller 50.

As shown in FIG. 1, an upstream end 28a and a downstream end 28b of the cathode channel 28 communicate with the atmosphere, respectively. An accessory provided at the cathode channel 28 includes a gas feed pump 38 connected to the cathode channel 28 on the upstream side of the cell stack 32. The gas feed pump 38 constitutes an air supply device for supplying air to the cathode 52.

An accessory disposed to the anode channel 26 includes a fuel pump 40 connected to a fuel supply port of the fuel tank 22 through a piping, a mixing tank 42 connected to an outlet of the fuel pump 40 through a piping, a liquid feed pump 43 connected to an outlet of the mixing tank 42, and a gas-liquid separator 44 connected to the anode channel 26 between the cell stack 32 and an exhaust valve 54. An outlet of the liquid feed pump is connected to the anode 47 of the cell stack 32 through the anode channel 26. The fuel pump 40 and the liquid feed pump 43 constitute a fuel supply device.

An outlet of the anode 47 of the cell stack 32 is connected to an inlet of the mixing tank 42 through the anode channel 26 and the gas-liquid separator 44. A discharged fluid discharged from the anode 47 of the cell stack 32, that is, an unreacted methanol aqueous solution, which is not used in a chemical reaction, and created carbon dioxide are supplied to the gas-liquid separator 44 and separated to a liquid and gas therein. The separated methanol aqueous solution is returned to the mixing tank 42 through the anode channel 26, and the carbon dioxide is discharged to the outside through the cathode channel 28 and the exhaust valve 54.

The cell controller 50 has a measuring module 51 electrically connected to the cell stack 32, supplies electricity generated in the cell stack 32 to the electronic equipment 53, measures a voltage of each single cell 140 of the cell stack 32, and controls a current drawn out from the cell stack.

When the fuel cell apparatus 10 arranged as described above is used as an electricity supply of the electronic equipment 53, first, the fuel tank 22 in which methanol is stored is mounted and connected to the circulating system 24 of the fuel cell apparatus 10. In this state, the fuel cell apparatus 10 starts to generate electricity. In this case, the fuel pump 40, the liquid feed pump 43, and a suction pump 48 are operated under the control of the cell controller 50. Highly concentrated methanol is supplied by the fuel pump 40 from the fuel tank 22 to the mixing tank 42 through the anode channel 26 and is diluted to a predetermined concentration by being mixed with water in the mixing tank. The methanol aqueous solution diluted in the mixing tank 42 is supplied by the liquid feed pump 43 to the anode 47 of the cell stack 32 through the anode channel 26.

In contrast, outside air, that is, air is sucked from the upstream end 38a of the cathode channel 28 by the air feed pump 48. The air passes through a suction filter 46, and dusts and impurities in the air are removed in the suction filter 46. After the air passes through the suction filter 46, it is supplied to the cathode 52 of the cell stack 32 passing through the cathode channel 28.

The methanol aqueous solution and the air supplied to the cell stack 32 chemically react with each other in the high polymer electrolytic membrane 144 interposed between the anode 47 and the cathode 52, thereby electricity is generated between the anode 47 and the cathode 52. The electricity generated in the cell stack 32 is drawn out from the cell stack 32 and supplied to the electronic equipment 53 by the cell controller 50.

In the cell stack 32, as reaction products, carbon dioxide is generated on the anode 47 side and water is generated on the cathode 52 side by the electrochemical reaction. The carbon dioxide generated on the anode 47 side and the methanol aqueous solution which is not used by the chemical reaction are supplied to the gas-liquid separator 44 through the anode channel 26, and the carbon dioxide is separated from the methanol aqueous solution in the gas-liquid separator 74. The methanol aqueous solution is supplied to the mixing tank .42 from the gas-liquid separator 44 through the anode channel 26 and used for electricity generation again. The separated carbon dioxide and splashed methanol pass through the cathode channel 28 together with air and discharged to the outside from the downstream end 28b of the cathode channel 28.

Vapor generated on the cathode 52 side of the cell stack 32 is supplied to the exhaust valve 54 through the cathode channel 28 and further discharged to the outside from the downstream end of the cathode channel 28.

In contrast, while the fuel cell apparatus 10 operates, the cell controller 50 monitors the voltages output from the respective single cells 140 in the cell stack 32 by the measuring module 51. In an ordinary operation state, each single cell outputs a voltage of, for example, 0.4 to 0.5V. When the fuel cell apparatus 10 continuously generates electricity, a cell voltage is gradually lowered and electricity generation efficiency is deteriorated. To cope with the above problem, the cell controller 50 monitors the voltages output from the respective single cells 140, and when the value of the voltage output from any one single cells 140 is made lower than a predetermined threshold value, for example, 0.4V, a refresh process is executed to restore electricity generation efficiency. In the embodiment, the electricity generation efficiency is restored by creating an insufficient air state by applying an excessive constant current load as a load current and reducing a cathode catalyst which is oxidized by being exposed to air for a long period of time as the refresh process.

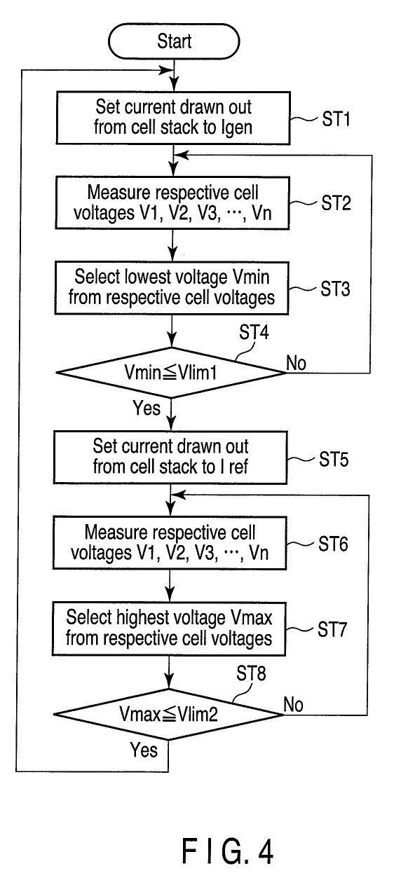

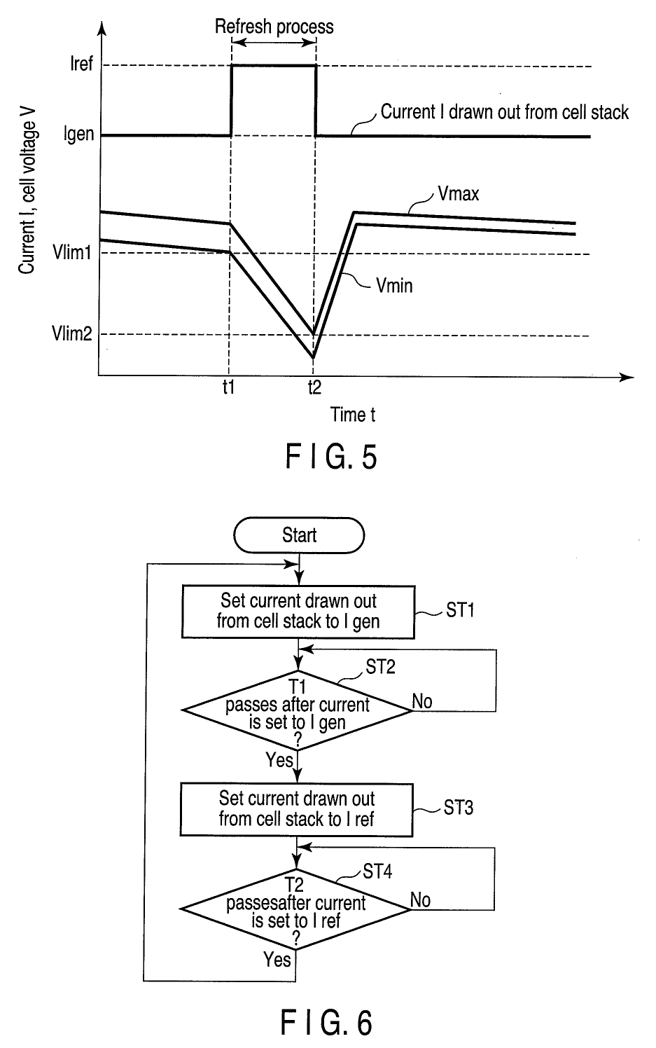

The refresh process will be explained below referring to FIGS. 4 and 5.

FIG. 4 is a view showing a flowchart of the refresh process, and FIG. 5 is a view showing a cell voltage and a change of a current drawn out from a cell. In FIGS. 4 and 5, respective symbols have means as shown below.

Vlim 1: a cell voltage (first threshold value 1), for example, 0.4V for starting the refresh process

Vlim 2: a cell voltage (second threshold value 2), for example, 0.1V for finishing the refresh process, wherein Vlim 2 and Vlim 1 have the relation of Vlim 2<Vlim 1

V1, V2, V3, . . . , Vn: voltages of respective cells, wherein n shows the number of single cells stacked on the cell stack

I gen: a current drawn out from the cell stack during ordinary electricity generation, for example, 100-200 mA/cm²

I ref: a current drawn out from the cell stack by the refresh process, wherein I ref and I gen have the relation of I ref>I gen

The cell controller 50 draws out a current I gen from the cell stack 32 and supplies it to the electronic equipment 53 during an ordinary operation (ST1). The cell controller 50 measures the output voltage values of the respective single cells 140 (ST2) and selects the lowest voltage Vmin in the measured cell voltages (ST3). The cell controller 50 compares the lowest voltage Vmin with the threshold value Vlim 1 (ST4), and when Vmin is equal to or larger than the threshold value Vlim 1, the process returns to ST2.

In contrast, when the Vmin threshold value Vlim 1 is smaller than the threshold value Vlim 1, the cell controller 50 determines that the refresh process is necessary and starts the refresh process. That is, the cell controller 50 increases the current drawn out from the cell stack 32 to I ref (ST5).

The current value of the current I ref is set to a current value 1 air[A] generated when an amount of air, which is larger than that supplied to the cathode electrode of the cell stack 32, is consumed, that is, to a value larger than a current value I air which is calculated from the amount of air supplied to the cell stack and by which air can be entirely consumed for electricity generation. The current value 1 air is determined by the following expression.

I air[A]=0.21×q[l/min]/(22.4[l/mol]×60[s/min])×⅔×6×F[C/mol]/n (Expression 1)

q: the amount of air flow supplied to the fuel cell apparatus (converted at 0° C., 1 atm)

F: Faraday constant (=96485)

n: the number of the single cells in the cell stack

When a current having a current value larger than the current value I air is drawn out from the cell stack 32, the insufficient air state is created in the cathode of the cell stack, thereby an oxidized cathode catalyst is reduced. The electricity generation efficiency is restored by the refresh process.

Note that during the refresh process, the gas feed pump 38 may be interrupted to stop supplying air or the gas feed pump 38 may be operated as it is so that air is continuously supplied.

Subsequently, the cell controller 50 measures the output voltage values of the respective single cells 140 (ST6) and selects the highest voltage Vmax in the measured cell voltages (ST7). The cell controller 50 compares the highest voltage VMmax with the threshold value Vlim 2 (ST8), and when Vmax is larger than the threshold value Vlim 2, it continues the refresh process. Further, when Vmax is equal to or smaller than the threshold value Vlim 2, the cell controller 50 determines that all the cells are placed in the insufficient air state by the refresh process and finishes the refresh process. Then, the cell controller 50 returns the current drawn out from the cell stack to I gen and resumes an ordinary electricity generation.

According to the fuel cell apparatus arranged as described above, even when the cathode catalyst is oxidized by a electricity generating operation executed for a long period and the electromotive section efficiency of the electromotive section is deteriorated, the electricity generation efficiency can be restored by creating an air insufficient state by the cathode (without shutting off an air flow) by executing the refresh process, that is, by drawing out an excessively large current from the cell stack and reducing the oxidized cathode catalyst. With this operation, a fuel cell apparatus can be obtained the electricity generation efficiency of which is improved and which can stably generate electricity for a long period of time. Further, since the refresh process can be executed even in, for example, a so-called passive type fuel cell apparatus having no gas feed pump regardless an arrangement of a cathode channel, there can be obtained a fuel cell apparatus and a drive method thereof which can effectively restore that an output from a fuel cell drops.

Next, a refresh process of a fuel cell apparatus according to a second embodiment of the present invention will be explained.

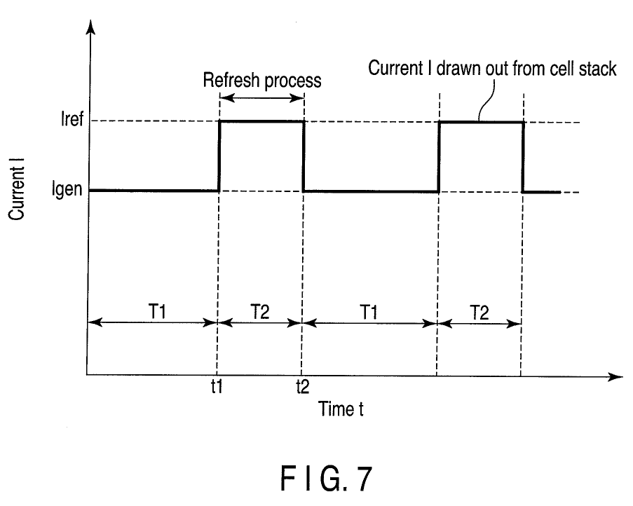

FIG. 6 is a view showing a flowchart of the refresh process, and FIG. 7 is a view showing a change of a current drawn out from a cell. Since an arrangement of the fuel cell apparatus is the same as that of the first embodiment described above, the detailed explanation thereof is omitted.

According to the second embodiment, if a cell controller 50 of the fuel cell apparatus does not measure the cell voltages of respective single cells, it executes the refresh process periodically regardless of the states of the respective single cells.

As shown in FIGS. 6 and 7, in an ordinary operation, the cell controller 50 draws out a current I gen from a cell stack 32 and supplies it to electronic equipment 53 (STl). When a predetermined period TI, for example, one hour has passed after electricity generation starts with the current I gen drawn out from the cell stack 32, the cell controller 50 determines that the refresh process is necessary and starts the refresh process. That is, the cell controller 50 increases the current drawn out from the cell stack 32 to the current I ref (ST3).

The current value of the current I ref is set to a value larger than the current value I air[A] which generated when air having an amount larger than the amount of air supplied to a cathode electrode of the cell stack 32 is consumed likewise the first embodiment.

When a predetermined period of time T2, for example, several tens of seconds are passed after the current drawn out from the cell stack 32 is set to I ref, the cell controller 50 determines that the respective single cells are placed in the air insufficient state, that is, determines that a cathode catalyst is reduced and the capability thereof is restored and finishes the refresh process (ST4). Then, the cell controller 50 returns the current drawn out from the cell stack 32 to I gen and resumes the ordinary electricity generation.

According to the fuel cell apparatus of the second embodiment arranged as described above, even when a cathode catalyst is oxidized by a electricity generating operation executed for a long period and the electricity generation efficiency of the electromotive section is deteriorated, the electricity generation efficiency can be restored by creating an air insufficient state by the cathode by executing the refresh process, that is, by drawing out an excessively large current from the cell stack and reducing the oxidized cathode catalyst. With this operation, a fuel cell apparatus can be obtained the electricity generation efficiency of which is improved and which can stably generate electricity for a long period of time. Since the refresh process can be executed even in, for example, a so-called passive type fuel cell apparatus having no gas feed pump regardless an arrangement of a cathode channel, there can be obtained a fuel cell apparatus and a drive method thereof which can effectively restore that an output from a fuel cell is lowered. Further, the cell controller can be simplified without measuring a cell voltage by periodically executing the refresh process regardless of a state of a cell voltage.

Note that, as other embodiment, the fuel cell apparatus may be driven simultaneously using a refresh process executed in response to a drop of a cell voltage and a refresh process executed each predetermined period of time. That is, when a cell voltage does not drop, the refresh process may be executed each predetermined period of time, and when a cell voltage drops within a predetermined period of time, the refresh process may be executed when the cell voltage drops.

The various modules of the systems described herein can be implemented as software applications, hardware and/or software modules, or components on one or more computers, such as servers. While the various modules are illustrated separately, they may share some or all of the same underlying logic or code.

While certain embodiments of the invention have been described, these embodiments have been presented by way of example only, and are not intended to limit the scope of the invention. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the fuel cell apparatus may omit the gas feed pump and may be arranged to supply air to the cell stack by diffusion and convection of air. In the cell stack, the number of the single cells stacked is not limited to that shown in the embodiments described above and can be increased or decreased as necessary. In the refresh process, a refresh process start voltage, a period of time of the refresh process, and the like are not limited to those shown in the embodiments described above and may be appropriately selected. The fuel cell apparatus according to the present invention can be also applied to other electronic equipment such as a personal computer, mobile equipment, a mobile terminal, and the like.

What is claimed is:

1. A fuel cell apparatus comprising:
an electromotive module comprising a cell comprising an anode and a cathode, and configured to generate electricity by a chemical reaction;
a fuel tank configured to store fuel;
a fuel channel configured to flow fuel through the anode, and an air channel configured to flow air through the cathode;
a fuel supply device configured to supply fuel supplied from the fuel tank to the anode through the fuel channel; and
a cell controller configured to control the generated electricity from the electromotive module and to execute a refresh operation in order to draw out electricity of a current value generated when an amount of air larger than the amount of air supplied to the cathode is consumed.

2. The fuel cell apparatus of claim 1, wherein the electromotive module comprises a cell stack arranged by stacking a plurality of single cells comprising an anode and a cathode opposing to each other across a high polymer membrane, and
the current value Iair is set to a current value prescribed by the following expression:
Iₐᵢᵣ[A]=0.21×q[litter/minute]/(22.4[litter/mol]×60[second/minute])×⅔×6×F[C/mol]/n (Expression 1)
q: the amount of air flow supplied to the fuel cell apparatus (converted at 0° C., 1 atmosphere)
F: Faraday constant (=96485)
n: the number of the single cells in the cell stack.

3. The fuel cell apparatus of claim 2, wherein the cell controller comprises a measuring module configured to measure the voltages of the respective single cells of the cell stack, the cell controller being configured to control a start of the refresh operation when the voltage of at least one single cell becomes equal to or lower than a first threshold value during a electricity generating operation and to finish the refresh operation when the voltages of all the single cells become equal to or lower than a second threshold value smaller than the first threshold value.

4. The fuel cell apparatus of claim 2, wherein the cell controller is configured to execute the refresh operation for a predetermined time at preset time intervals.

5. The fuel cell apparatus of claim 1, comprising a gas feed pump configured to supply air to the electromotive module through the cathode channel.

6. A method of driving a fuel cell apparatus comprising an electromotive module comprising a cell comprising an anode and a cathode and configured to generate electricity by a chemical reaction, a fuel tank configured to store fuel, a fuel channel configured to flow fuel through the anode, and an air channel configured to flow air through the cathode, a fuel supply device configured to supply fuel supplied from the fuel tank to the anode through the fuel channel, and a cell controller configured to control the generated electricity from the electromotive module, the method comprising:
drawing out an electricity of a current value generated when an amount of air larger than the amount of air supplied to the cathode is consumed;
creating an insufficient air state in the cathode; and
executing a refresh operation for reducing the cathode.

7. The method of claim 6, comprising:
measuring the voltages of the cells;
starting the refresh operation when the voltage of at least one cell becomes equal to or lower than a first threshold value during an electricity generating operation; and
finishing the refresh operation when the voltages of all the cells becomes equal to or lower than a second threshold value smaller than the first threshold value.

8. The method of claim 6, comprising executing the refresh operation for a predetermined time at preset time intervals.
